(19) United States
(12) Patent Application Publication
(10) Pub. No.: US 2018/0169998 A1
(43) Pub. Date: Jun. 21, 2018

(54) LAMINATE

(71) Applicant: FUJIFILM Corporation, Tokyo (JP)

(72) Inventor: Junichi HIRAKATA, Minami-ashigara-shi (JP)

(73) Assignee: FUJIFILM Corporation, Tokyo (JP)

(21) Appl. No.: 15/860,516

(22) Filed: Jan. 2, 2018

Related U.S. Application Data
(63) Continuation of application No. PCT/JP2016/071597, filed on Jul. 22, 2016.

(30) Foreign Application Priority Data
Jul. 23, 2015 (JP) 2015-146214

(51) Int. Cl. B32B 7/02; B32B 15/08; B32B 27/30; B32B 27/32; B32B 27/34; B32B 27/36

(52) U.S. Cl. CPC B32B 7/02; B32B 15/08; B32B 27/308; B32B 27/32; B32B 27/34; B32B 2307/736; B32B 2307/202; B32B 2307/412; B32B 2310/0418; B32B 2313/04; B32B 2307/30; B32B 27/36

(57) ABSTRACT

An object of the present invention is to provide a laminate useful as a transparent conductive film in which curved surface molding can be performed without impairing conductivity. The laminate according to the present invention is a laminate including a substrate and a conductive layer, a haze value is less than 10%, and a thermal shrinkage rate of the substrate is 5% to 75%.

### CROSS-REFERENCE TO RELATED APPLICATIONS

This application is a Continuation of PCT International Application No. PCT/JP2016/071597 filed on Jul. 22, 2016, which claims priority under 35 U.S.C. § 119(a) to Japanese Patent Application No. 2015-146214 filed on Jul. 23, 2015. The above application is hereby expressly incorporated by reference, in its entirety, into the present application.

### BACKGROUND OF THE INVENTION

### 1. Field of the Invention

The present invention relates to a laminate having a substrate and a conductive layer.

### 2. Description of the Related Art

Recently, a thin and lightweight flexible display device attracts attention.

As such a flexible display device, in addition to a liquid crystal display device in the related art, electronic paper in types such as an electronic powder fluid type, a microcapsule type, an electrophoretic type; and an organic electroluminescence (EL) display using an organic light emitting body such as diamines are known.

Also in such a flexible display device, a transparent conductive film is adopted as an electrode. Since such a flexible display is also installed on an extremely curved surface such as a pillar, the applied transparent conductive film is also required to have not only transparency but also bending resistance.

Therefore, in a case where the transparent conductive film does not have moderate bending resistance, cracks may occur in a case where the flexible display device is bent, and the flexible display device may not conduct.

Under this circumstance, with respect to a technique of forming a bendable transparent conductive film, there are suggestions in various perspectives.

For example, JP2008-103329A discloses a technique of forming a carbon nanotube thin film on a transparent substrate instead of an ITO electrode poor in flexibility.

In addition, JP2011-003456A discloses a technique of forming a transparent conductive film on a plastic substrate.

### SUMMARY OF THE INVENTION

Recently, in addition to merely bending as described above, a demand for processing a display device into a shape having complicated curved surfaces such as clothes and glasses, and a dimming device is required to be set as a free molded body curved three-dimensionally.

However, the present inventors have conducted research, have found that, in the carbon nanotube of JP2008-103329A, a substrate was stretched in a case of molding to a curved surface to generate cracks and similarly have found that, also in the plastic substrate of JP2011-003456A, a substrate was stretched in a case of molding to the curved surface, cracks are generated in the transparent conductive film accompanying the stretching of the substrate, so as to cause the substrate to not be conducted.

Therefore, in fact, a transparent conductive film molded so as to follow a complicated curved surface or a surface of a three-dimensionally curved molded body has not been obtained.

Accordingly, an object of the present invention is to provide a laminate useful as a transparent conductive film in which curved surface molding can be performed without impairing conductivity.

The present inventors have conducted research in various ways to find that molding can be performed into a desired shape while the conductivity of the conductive layer is maintained, in a case where the conductive layer manufactured on the substrate is thermoformed so as to shrinks to follow a curved surface which is extremely curved.

It is considered that, since the substrate only thermally shrinks without being stretched, the tearing force against the conductive layer does not work, such that and cracks are not generated and the conductivity does not deteriorate.

That is, the present inventors have found that the above objects can be achieved by the following configurations.

[1] A laminate comprising: a substrate; and a conductive layer, in which a haze value is less than 10%, and in which thermal shrinkage rate of the substrate is 5% to 75%.

[2] The laminate according to [1], in which the conductive layer is a transparent conductive layer, and in which a transmittance of the laminate is 60% or greater.

[3] The laminate according to [1] or [2], in which a thickness of the substrate is 10 to 500 μm.

[4] The laminate according to [1] to [3], in which the substrate is stretched in a range of greater than 0% and 300% or less.

[5] The laminate according to any one of [1] to [3], in which the substrate is a substrate that is not stretched.

According to the present invention, it is possible to provide a laminate useful as a transparent conductive film in which curved surface molding can be performed without impairing conductivity.

### BRIEF DESCRIPTION OF THE DRAWINGS

FIG. 1A is a schematic view illustrating a conceptual diagram in the case of curved surface molding by using the laminate of the present invention, and is a schematic view illustrating a state before heating molding.

FIG. 1B is a schematic view illustrating a conceptual diagram in the case of curved surface molding by using the laminate of the present invention, and is a schematic view illustrating a state after heating molding.

### DESCRIPTION OF THE PREFERRED EMBODIMENTS

Hereinafter, the present invention will be described in detail.

The description in the configurations described below is provided based on typical embodiments of the present invention, but the present invention is not limited to the embodiments.

In the present specification, the numerical range expressed by using “to” means a range including numerical values described before and after “to” as a lower limit value and an upper limit value.

In this specification, the expression “parallel or orthogonal” does not mean parallel or orthogonal in a strict sense but means a range of ±5° from parallel or orthogonal.

<Thermal Shrinkage Rate>

The thermal shrinkage rate in the present invention is a value measured by the following method.

In the measurement of the thermal shrinkage rate, a 1-cm grid square was stamped on one surface of the film in order to cut out a measurement sample having a length of 15 cm and a width of 3 cm with the measurement direction as the long side and to measure the film length. A point at 3 cm from the upper portion of the long side of 15 cm on the center line of the width of 3 cm was A, and a point at 2 cm from the lower portion of the long side was B, and a distance AB between the both=10 cm was an initial film length L₀. A portion to 1 cm from the upper portion of the long side was clamped with a clip having a width of 5 cm, and the film clamped with the clip was hung on the ceiling of the oven heated to the glass transition temperature (Tg) of the film. At this point, the weight on the film was not lowered and was set in a tension-free state. After 5 minutes have passed from the heating of the entire film sufficiently evenly, the film is taken out of the oven together with the clip, and the length L between the points AB after the thermal shrinkage rate was measured, so as to obtain the thermal shrinkage by Equation 2.

Thermal shrinkage rate (%)=100×(L₀−L)/L₀ (Equation 2)

<Glass Transition Temperature (Tg)>

Tg of the substrate used in the present invention can be measured by using a differential scanning calorimeter.

Specifically, a differential scanning calorimeter DSC 7000X manufactured by Hitachi High-Tech Science Corporation was used, measurement was performed under a nitrogen atmosphere and a temperature rising rate of 20 ° C./min, and a temperature at a point in which the tangent lines of the respective DSC curves at a peak top temperature of the time-differentiated DSC curve (DDSC curve) of the obtained result and a temperature obtained by subtracting 20° C. from the peak top temperature intersect with each other was Tg.

<Haze Value and Transmittance>

The haze value and the transmittance (total light transmittance) in the present invention are values measured with an automatic haze meter TC-H III DPK (according to JIS K7136) manufactured by Tokyo Denshoku Co., Ltd.

<Sheet Resistance Value>

According to the present invention, the sheet resistance value is used as an index of conductivity.

The sheet resistance value is a value measured by using a resistivity meter (LORESTA GP MCP-T600, manufactured by Mitsubishi Chemical Corporation) and an ESP probe (MCP-TP08P) under environments of 25° C. and a relative humidity of 55%.

However, in a case where the sheet resistance cannot be directly measured by the above method due to lamination of another layer (insulating layer and the like) on the target to be measured or the like, the sheet resistance value is a value using a non-contact sheet resistance meter such as an eddy current type resistance meter that is calibrated by the above measuring method.

<Laminate>

A laminate according to the present invention is a laminate having a substrate and a conductive layer, a haze value is less than 10%, and a thermal shrinkage rate of the substrate is 5% to 75%.

The laminate of the present invention is preferably a thermal shrinkable laminate, that is, a laminate applicable to molding application before thermal shrinkage.

The laminate of the present invention is used as an electrode of a flexible display device, and shrinkage is used such that the laminate can be molded without deteriorating conductivity even in a case where the laminate is molded so as to follow a complicated three-dimensional curved surface.

The laminate of the present invention can also be used as a film heater. In a case where the laminate is used as a film heater, the following effects can be exhibited.

(1) While the maximum flexibility is maintained, the surface can be heated with less unevenness in temperature distribution as a heater. For example, a coloring agent that can thermotropically convert coloration and decoloration can be used so as to thermotropically switch a transparent state and a light-shielding state by heating.

(2) Since heat may be generated on the entire surface of the conductive film to generate heat, by performing conversion thermotropically, the resistance value can be set to increase to some extent so as to increase the transmittance.

With respect to the laminate of the present invention, the transmittance is preferably 70% or greater and particularly preferably 80% or greater.

The laminate of the present invention is not particularly limited as long as the haze value is less than 10%. For example, in a case where a liquid crystal cell is manufactured by using the laminate of the present invention, in view of enhancement the contrast between the transparent state and the light-shielding state, the haze value is preferably 0.1% to 5% and more preferably 0.4% to 4.0%.

[Substrate]

The substrate used in the present invention is a substrate that has flexibility and that can adjust the thermal shrinkage rate and the haze to desired values, in a case where the substrate is used as the laminate of the present invention.

With respect to the substrate used in the present invention, a thermal shrinkage rate is 5% to 75%, preferably 10% to 45%, and more preferably 10% to 20%.

With respect to the substrate according to the present invention, the maximum thermal shrinkage rate in the in-plane direction of the substrate is preferably 5% to 75%, more preferably 7% to 60%, and even more preferably 10% to 45%. In the case where stretching is performed as means for shrinkage, the in-plane direction in which the thermal shrinkage rate becomes the greatest is substantially identical to the stretching direction.

With respect to the substrate used in the present invention, the thermal shrinkage rate in the direction orthogonal to the in-plane direction in which the thermal shrinkage rate is the maximum is preferably 0% to 5% and more preferably 0% to 3%.

The in-plane direction in which the thermal shrinkage rate becomes maximum be specified by the direction in which measurement samples were cut out in increments of 5° in a case where the thermal shrinkage rate is measured under the conditions described above, the thermal shrinkage rates in the in-plane direction of all the measurement samples were measured, and the value thereof becomes maximum.

The substrate used in the present invention preferably is formed of a thermoplastic resin.

Examples of the thermoplastic resin suitably include a polymer film excellent in optical transparency, mechanical strength, heat stability, and the like.

Examples of the polymer included in the polymer film include a polycarbonate-based polymer; a polyester-based polymer such as polyethylene terephthalate (PET) and polyethylene naphthalate (PEN); an acrylic polymer such as polymethyl methacrylate (PMMA); and a styrene-based polymer such as polystyrene and an acrylonitrile/styrene copolymer (AS resin).

Examples thereof include polyolefin such as polyethylene and polypropylene; a polyolefin-based polymer such as a norbornene resin and an ethylene/propylene copolymer; an amide-based polymer such as a vinyl chloride-based polymer, nylon, and aromatic polyamide; an imide-based polymer; a sulfone-based polymer; a polyether sulfone-based polymer; a polyetheretherketone-based polymer; a polyphenylene sulfide-based polymer; a vinylidene chloride-based polymer; a vinyl alcohol-based polymer; a vinyl butyral-based polymer; an arylate-based polymer; a polyoxymethylene-based polymer; an epoxy-based polymer; a cellulose-based polymer such as triacetyl cellulose; and a copolymer obtained by copolymerizing monomer units of these polymers.

Examples of the polymer film include a film formed by mixing two or more polymers provided above.

The substrate used in the present invention can also be formed as a cured layer of an ultraviolet curing-type or thermosetting-type resin such as acrylic resin, a urethane-based resin, an acrylic urethane-based resin, an epoxy-based resin, or a silicone-based resin.

The means for adjusting the thermal shrinkage rate is not particularly limited. However representative examples thereof include adjustment by stretching a substrate in the process of film formation. Also, effects owing to shrinkage of the substrate (for example, a method of cooling down to a temperature below the glass transition temperature in the middle of shrinkage and stopping shrinkage), shrinkage due to residual strain at the time of film formation, shrinkage due to a residual solvent, and the like can be used.

{Thickness}

The substrate used in the present invention is preferably 10 μm to 500 μm, more preferably 20 μm to 400 μm, and even more preferably 30 μm to 300 μm, in practice.

{Stretching step}

The substrate used in the present invention may be an unstretched substrate or may be a stretched substrate. The stretching ratio is not particularly limited, and may be greater than 0% which is unstretched, and the stretching may be performed up to 300%. In the stretching step in practice, the stretching ratio is preferably greater than 0% and 200% or less and more preferably greater than 0% and 100% or less.

The stretching may be performed in the film conveyance direction (machine direction), may be performed in a direction orthogonal to the film conveyance direction (lateral direction), or may be performed in both directions.

The stretching temperature is preferably before and after the glass transition temperature Tg of the film used, more preferably Tg±0° C. to 50° C., even more preferably Tg+0° C. to 40° C., and particularly preferably Tg±0° C. to 30° C.

In the stretching step, the substrate may be simultaneously stretched in biaxial directions or may be stretched sequentially in biaxial directions. In a case where the substrate is sequentially stretched in biaxial directions, the stretching temperature may be changed for each stretching in each of the directions.

On the other hand, in the case where the substrate is stretched in biaxial directions, it is preferable that the substrate is first stretched in the direction parallel to the film conveyance direction and then stretched in the direction orthogonal to the film conveyance direction. A more preferable range of the stretching temperature for performing the sequential stretching is the same as the stretching temperature range for performing simultaneous biaxial stretching.

[Conductive Layer]

The conductive layer used in the present invention is a layer that is provided on a substrate and has conductivity.

In the present invention, “having conductivity” means that the sheet resistance value is 0.1 Ω/□ to 10,000 Ω/□, and generally includes those called an electric resistance layer.

In the case where the laminate of the present invention is used as an electrode of a flexible display device or the like, the sheet resistance value is preferably low. Specifically, the sheet resistance value is preferably 300 Ω/□ or less, particularly preferably 200 Ω/□ or less, and most preferably 100 Ω/□ or less.

The conductive layer used in the present invention is preferably transparent. According to the present invention, the expression “being transparent” means that the transmittance is 60% to 99%.

The transmittance of the conductive layer is preferably 75% or greater, particularly preferably 80% or greater, and most preferably 90% or greater.

The thermal shrinkage rate of the conductive layer used in the present invention is preferably close to the thermal shrinkage rate of the substrate. In a case where such a conductive layer is used, it is possible to cause the conductive layer to follow to the shrinkage of the substrate, a short circuit to hardly occur in the conductive layer, and the change in the electric resistivity to be suppressed to a small value.

Specifically, the thermal shrinkage rate of the conductive layer is preferably 50% to 150% of the thermal shrinkage rate, more preferably 80% to 120% of the thermal shrinkage rate, and even more preferably 90 to 110% of the thermal shrinkage rate with respect to the thermal shrinkage rate of the substrate.

Examples of the materials that can be used in the conductive layer used in the present invention include metal oxide (Indium Tin Oxide: ITO and the like), carbon nanotubes (Carbon Nanotube: CNT, Carbon Nanobud: CNB, and the like), graphene, polymer conductors (polyacetylene, polypyrrole, polyphenol, polyaniline, PEDOT/PSS, and the like), metal nanowires (silver nanowires, copper nanowires, and the like), and metal mesh (silver mesh, copper mesh, and the like).

In view of thermal shrinkage rate, the conductive layer of the metal mesh is preferably a conductive layer formed by dispersing conductive fine particles of silver, copper, or the like in a matrix rather than a conductive layer formed of metal only.

Metal oxide such as ITO is a ceramic material. As in the related art, in the case where molding is performed without using shrinkage, there has been a problem in that, cracks were easily generated due to a stretching action, and the sheet resistance value remarkably increased.

On the other hand, according to the present invention, the generation of cracks can be suppressed by using shrinkage, the problem of exhibiting the high sheet resistance value, which has been a problem in the related art, can be solved, and the laminate of the present can be used as a conductive layer.

It is preferable that a conductive layer obtained by dispersing particles such as a metal mesh form, a carbon nanotube form, and a metal nanowire in a matrix is caused to have the glass transition temperature (Tg) in the matrix to be lower than the conductive layer temperature of the substrate, since the conductive layer can be caused to easily follow the shrinkage of the substrate, the generation of wrinkles can be suppressed compared with the shrinkage temperature using metal oxide or a polymer conductor, and the increase of haze can be suppressed.

[Alignment layer]

In a case where the laminate according to the present invention is used as a liquid crystal cell substrate, the laminate may have an alignment layer in order to align the liquid crystalline composition.

The alignment layer used in the present invention may be an alignment layer that horizontally aligns the liquid crystalline composition or may be alignment layer that vertically aligns the liquid crystalline composition in a case where a voltage is not applied.

The alignment layer is not particularly limited, and various alignment layers such as an alignment layer using a polymer, an alignment layer subjected to a silane coupling treatment, an alignment layer using a quaternary ammonium salt, an alignment layer obtained by vapor depositing silicon oxide from an oblique direction, and an alignment layer using photoisomerization can be used.

The alignment layer using a polymer is preferably any one of a layer using polyamic acid or polyimide; a layer using modified or unmodified polyvinyl alcohol; a layer using modified or unmodified polyacrylic acid; and a layer using a (meth) acrylic acid copolymer including any of a repeating unit represented by Formula (I), a repeating unit represented by Formula (II), and a repeating unit represented by Formula (III).

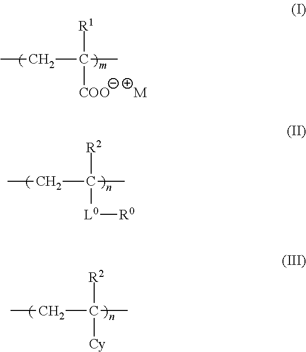

In Formulae (I) to (III), R′ and R² each independently represent a hydrogen atom, a halogen atom, or an alkyl group having 1 to 6 carbon atoms; M is a proton, an alkali metal ion, or an ammonium ion; L⁰ is a divalent linking group selected from the group consisting of —O—, —CO—, —NH—, —SO₂—, an alkylene group, an alkenylene group, an arylene group, and combinations thereof; R⁰ is a hydrocarbon group having 10 to 100 carbon atoms or a fluorine atom-substituted hydrocarbon group having 1 to 100 carbon atoms; Cy is an aliphatic cyclic group, an aromatic group, or a heterocyclic group and particularly preferably has a carbazole group; m is 10 to 99 mol %; and n is 1 to 90 mol %.

“(Meth)acrylic acid” is a denotation indicating acrylic acid or methacrylic acid.

Among these, it is preferable to use an alignment layer including any one of polyimide, a compound represented by Formulae (I) to (III), and a silane coupling agent, in view of alignment ability, durability, insulation properties, and cost, and it is particularly preferable to use an alignment layer including any one of polyimide or a compound that is represented by any one of Formulae (I) to (III) and has a carbazole group.

[Photo Spacer]

In a case where the laminate of the present invention is used as a substrate of a flexible display device, it is necessary to keep a desired gap between the substrates depending on the type of the flexible display device.

In order to deal with such a case, the laminate of the present invention may have a spacer.

A material and a method of forming the spacer are not particularly limited, and examples thereof include a spacer formed by photolithography by using a photosensitive composition. A spacer formed using such a photosensitive composition is called a photo spacer.

The process for manufacturing the photo spacer is not particularly limited, and examples thereof include a process of sequentially performing a “layer forming step” of forming a photosensitive resin layer including a photosensitive composition on a laminate and a “patterning step” of exposing and developing the photosensitive resin layer formed on the laminate to reveal a desired pattern.

The photosensitive composition used in the photo spacer may be a negative type or a positive type, and is not particularly limited. The components constituting the photosensitive composition are not particularly limited, and examples thereof include (1) alkali-soluble binder, (2) a monomer or an oligomer, and (3) a photopolymerization initiator, a photopolymerization initiator system, or the like.

(1) Alkali-Soluble Binder

As the alkali-soluble binder constituting the photosensitive composition, a polymer having a polar group such as a carboxylic acid group or a carboxylic acid salt group in the side chain is preferable. Examples thereof include a methacrylic acid copolymer, an acrylic acid copolymer, an itaconic acid copolymer, a crotonic acid copolymer, a maleic acid copolymer, and a partially esterified maleic acid copolymer as disclosed in JP1984-44615A (JP-S59-44615A), JP1979-34327B (JP-S54-34327B), JP1983-12577B (JP-558-12577B), JP1979-25957B (JP-554-25957B), JP1984-53836A (JP-559-53836A), and JP1984-71048A (JP-S59-71048A). Examples thereof also include cellulose derivatives having a carboxylic acid group in a side chain, or include those obtained by adding a cyclic acid anhydride to a polymer having a hydroxyl group. Preferred examples include a copolymer of benzyl (meth)acrylate and (meth)acrylic acid and a multi-component copolymer of benzyl (meth)acrylate, (meth)acrylic acid, and another monomer as disclosed in U.S. Pat. No. 4,139,391B, and Compounds P-1 to P-35 of JP2008-146018A. These polymers having polar groups may be used singly or may be used in a state of a composition in combination with a general film forming polymer. The content of the polymer is generally 20 to 50 mass % and preferably 25 to 45 mass % with respect to the total solid content.

Here, the expression “(meth)acrylate” is a denotation indicating acrylate or methacrylate.

(2) Monomer or Oligomer

The monomer or oligomer constituting the photosensitive composition is preferably a monomer or an oligomer having two or more ethylenically unsaturated double bonds and performing addition polymerization by irradiation with light. Such a monomer and an oligomer include a compound having at least one addition polymerizable ethylenically unsaturated group in a molecule and having a boiling point of 100° C. or higher at normal pressure. Examples thereof include monofunctional acrylate and monofunctional methacrylate such as polyethylene glycol mono(meth)acrylate, polypropylene glycol mono(meth)acrylate, and phenoxyethyl (meth)acrylate; polyethylene glycol di(meth)acrylate, polypropylene glycol di(meth)acrylate, trimethylol ethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl) ether, tri(acryloyloxyethyl) isocyanurate, tri(acryloyloxyethyl) cyanurate, and glycerin tri(meth)acrylate; and polyfunctional acrylate and polyfunctional methacrylate such as those obtained by adding ethylene oxide or propylene oxide to polyfunctional alcohol such as trimethylolpropane or glycerin and performing (meth)acrylation.

Examples thereof include polyfunctional acrylates and methacrylates such as urethane acrylates disclosed in JP1973-41708B (JP-S48-41708B), JP1975-6034B (JP-S50-6034B), and JP1976-37193A (JP-S51-37193A); polyester acrylates disclosed in JP1973-64183A (JP-S48-64183A), JP1974-43191B (JP-S49-43191B), and JP1977-30490B (JP-S52-30490B); and epoxy acrylates which are reaction products of an epoxy resin and (meth) acrylic acid. Among these, trimethylolpropane tri(meth)acrylate, pentaerythritol tetra(meth)acrylate, dipentaerythritol hexa(meth)acrylate, and dipentaerythritol penta(meth)acrylate are preferable. Examples thereof also include “Polymerizable Compound B” disclosed in JP1999-133600A (JP-H11-133600A), as a preferable example. These monomers or oligomers may be used singly or two or more kinds thereof may be used in a mixture. The content thereof is generally 5 to 50 mass % and preferably 10 to 40 mass % with respect to the total solid content of the photosensitive composition.

The total content of the monomer or the oligomer and the binder is preferably 30 to 90 mass %, more preferably 40 to 80 mass %, and particularly preferably 50 to 70 mass % with respect to the total solid content. The ratio of the monomer or the oligomer/the binder is preferably 0.5 to 1.2, more preferably 0.55 to 1.1, and particularly preferably 0.6 to 1.0.

(3) Photopolymerization initiator or photopolymerization initiator system

Examples of the photopolymerization initiator or the photopolymerization initiator system constituting the photosensitive composition include a vicinal polyketaldonyl compound disclosed in U.S. Pat. No. 2,367,660B, an acyloin ether compound disclosed in U.S. Pat. No. 2,448,828B, an aromatic acyloin compound substituted with a-hydrocarbon disclosed in U.S. 2,722,512B, a polynuclear quinone compound disclosed in U.S. Pat. No. 3,046,127B and U.S. Pat. No. 2,951,758B, a combination of triarylimidazole dimer and p-aminoketone disclosed in U.S. Pat. No. 3,549,367B, a benzothiazole compound and a trihalomethyl-s-triazine compound disclosed in JP1976-48516B (JP-S51-48516B), a trihalomethyl-triazine compound disclosed in U.S. Pat. No. 4,239,850B, and a trihalomethyloxadiazole compound disclosed in U.S. Pat. No. 4,212,976B. Trihalomethyl-s-triazine, trihalomethyloxadiazole, and triarylimidazole dimer are particularly preferable. Examples thereof also include “Polymerizable Compound C” disclosed in JP1999-133600A (JP-H11-133600A), as a preferable example. These photopolymerization initiators or photopolymerization initiator systems may be used singly or two or more kinds thereof may be used in a mixture. The content of the photopolymerization initiator or the photopolymerization initiator system is generally 0.5 to 20 mass % and is preferably 1 to 15 mass % with respect to the total solid content of the photosensitive composition.

The photosensitive composition may also include a surfactant for preventing unevenness in case of coating and fine particles for increasing the strength as a photo spacer.

{Layer Forming Step}

The layer forming step is a step of forming a photosensitive resin layer including a photosensitive composition on a laminate. Examples of the method for forming the photosensitive resin layer on the laminate include (a) a method of coating a laminate with a solution including a photosensitive composition by a well-known coating method and (b) a method of coating a temporary support with a solution including a photosensitive composition by a well-known coating method to form a photosensitive resin layer and then transferring the photosensitive resin layer to a laminate. Hereinafter, these methods will be described in detail.

(a) Coating Method

Examples of the coating method of the photosensitive composition include well-known coating methods such as a spin coating method, a curtain coating method, a slit coating method, a dip coating method, an air knife coating method, a roller coating method, a wire bar coating method, a gravure coating method, or an extrusion coat method using a popper disclosed in U.S. Pat. No. 2,681,294B. Among these, a method using a slit nozzle or a slit coater disclosed in JP2004-89851A, JP2004-17043A, JP2003-170098A, JP2003-164787A, JP2003-10767A, JP2002-79163A, and JP2001-310147A is suitable.

(b) Transfer Method

In the case of transferring is performed, a photosensitive resin transfer film is used to bond a photosensitive resin layer formed in a film shape on a temporary support to the laminate by pressurization or thermal pressurization with a heated and/or pressurized roller or flat sheet, and then the photosensitive resin composition layer is transferred to the laminate by peeling off the temporary support. Specific examples thereof include laminators and lamination methods disclosed in JP1995-110575A (JP-H07-110575A), JP1999-77942A (JP-H l 1-77942A), JP2000-334836A, and JP2002-148794A. In view of reducing foreign substances, a method disclosed in JP1995-110575A (JP-H07-110575A) is preferably used.

{Patterning Step}

The patterning step is a step of exposing and developing the photosensitive resin layer formed on the laminate to obtain a desired pattern. Specific examples of the patterning step include steps disclosed in paragraphs [0040] to [0051] of JP2006-23696A and steps disclosed in paragraphs [0072] to [0077] of JP2006-64921A, as suitable examples in the present invention.

Meanwhile, a method other than photolithography can be used as a method for forming the spacer. In this case, the method is not particularly limited, but a method capable of forming a desired pattern is preferable, and specifically, screen printing or inkjet printing is preferable. It is also preferable that a step of post-curing by light or heat is added in addition to the above method. The spacer material suitable for these methods is not particularly limited, but it is preferable to have at least (1) a monomer or oligomer and (2) a photopolymerization initiator and/or a thermal polymerization initiator.

Further, a resin or an inorganic compound molded in a predetermined shape (preferably spherical shape) in advance may be sprayed on the laminate to be used as a spacer. In this case, it is also preferable to fix the spacer on the laminate such that the spacer does not move from above the laminate. The fixing method is not particularly limited. However, examples thereof include a method of covering the surface of the spacer with a layer of a thermal adhesive or a light adhesive, spraying the spacer on the laminate, and then performing bonding and a method of dispersing a spacer in a coating solution having a polymerizable compound (a monomer, an oligomer, a crosslinkable polymer, or the like), coating a laminate, and burying and fixing a portion of the spacer.

The shape of the spacer is not particularly limited, and any shape such as a columnar shape, a wall shape, and a network shape in which wall-shaped spacers intersect each other may be taken. The occupancy of the spacer occupying the area of the laminate is preferably in the range of 0.03% to 40%, more preferably in the range of 0.1% to 20%, and particularly preferably in the range of 0.3% to 15%. The spacers may be arranged on the laminate at a substantially uniform density or, on the contrary, the spacers may be densely arranged.

The spacer may be formed directly on the conductive layer of the laminate of the present invention or may be formed on another layer formed on the conductive layer. Examples of the layer disposed between the conductive layer and the spacer in the latter case include an alignment layer described in another section and an insulating layer for preventing unintentional energization.

### EXAMPLES

Hereinafter, the present invention is specifically described with reference to examples. Materials, reagents, substance amounts, and proportions thereof, operations, and the like shown in the following examples can be appropriately changed without departing from the gist of the present invention. Therefore, the present invention is not restricted to be limited to the following examples.

### Example 1

<Preparation of Laminate 1>

A stretched PET film (KOPALON PET tube, manufactured by GUNZE Limited, thickness 100 μm) was cut from a tubular form into a sheet shape and fixed to a washed 300 mm×400 mm×0.7 mm glass plate with a heat resistant tape on four sides. A portion of the surface of the PET film was masked with a heat resistant tape to a size of 3 mm×10 mm.

A sputtering apparatus (51H3030 manufactured by ULVAC Technologies, Inc.) was used, under the conditions of main current: 3A, preheat temperature: 100° C., sputtering temperature: 100° C., preheat time: 10 minutes, Ar flow rate: 84 sccm, and O₂ flow rate: 2 sccm, the above glass plate was transported at a speed of 220 mm/min in a film forming chamber, and ITO was sputtered as a conductive layer on the surface of the stretched PET film. Thereafter, the stretched PET film with the conductive layer was peeled off from the glass plate in an environment of 23° C. and 50% relative humidity to prepare Laminate 1. The thickness of the conductive layer was 77 nm.

For the target material, an ITO (4 N) target material (In₂O₃-10 wt% SnO₂ purity99.99%) manufactured by ULVAC Technologies, Inc. was used.

Laminate 1 prepared was cut to 10 cm square, and the transmittance, the sheet resistance value, and the haze were measured according to the method described above. Results thereof are as presented in Table 1.

The Tg of the substrate used was 80° C., and the thermal shrinkage rate in the transverse direction (TD) direction measured according to the method described above was 35%. The in-plane direction in which the thermal shrinkage rate of the substrate became the maximum was substantially identical to the TD direction, and the thermal shrinkage rate in the machine direction (MD) direction orthogonal to the in-plane direction was 10%.

### Example 2

<Preparation of Laminate 2>

In Example 1, Laminate 2 of Example 2 was prepared in the same manner as in Example 1 except for using a polycarbonate (PC) film (manufactured by Teijin Limited, thickness of 100 μm) stretched by 100% in the TD direction instead of the stretched PET film in at a stretching temperature of 150° C. The thickness of the conductive layer was 77 nm.

In the same manner as in Example 1, the transmittance, the sheet resistance value, and the haze of the laminate were measured according to the method described above. Results thereof are as presented in Table 1.

The Tg of the substrate used was 150° C., and the thermal shrinkage in the TD direction measured according to the method described above was 33%. The in-plane direction in which the thermal shrinkage rate of the substrate became the maximum was substantially identical to the TD direction, and the thermal shrinkage rate in the MD direction orthogonal to the in-plane direction was 3%.

### Example 3

<Preparation of Laminate 3>

In Example 1, Laminate 3 of Example 3 was prepared in the same manner as in Example 1 except for using a cycloolefin polymer (COP) film (ARTON G7810, manufactured by JSR Corporation, thickness 100 μm) stretched by 100% in the TD direction instead of the stretched PET film at a stretching temperature of 170° C. The thickness of the conductive layer was 77 nm.

In the same manner as in Example 1, the transmittance, the sheet resistance value, and the haze of the laminate were measured according to the method described above. Results thereof are as presented in Table 1.

The Tg of the substrate used was 170° C., and the thermal shrinkage in the TD direction measured according to the method described above was 32%. The in-plane direction in which the thermal shrinkage rate of the substrate became the maximum was substantially identical to the TD direction, and the thermal shrinkage rate in the MD direction orthogonal to the in-plane direction was 3%.

### Example 4

<Preparation of Laminate 4>

In Example 1, Laminate 4 of Example 4 was prepared in the same manner as in Example 1 except for using a cellulose ester film having a degree of substitution of 2.42 (thickness: 100 μm) stretched by 100% in the TD direction instead of the heat shrinkable PET film at a stretching temperature of 200° C.

This cellulose ester film was formed by casting a 20 weight % solution using methylene chloride and methanol (mixing ratio 85:15) as a solvent onto a SUS substrate by a casting method and drying the solvent. The thickness of the conductive layer was 77 nm.

In the same manner as in Example 1, the transmittance, the sheet resistance value, and the haze of the laminate were measured according to the method described above. Results thereof are as presented in Table 1.

The Tg of the substrate used was 180° C., and the thermal shrinkage in the TD direction measured according to the method described above was 30%. The in-plane direction in which the thermal shrinkage rate of the substrate became the maximum was substantially identical to the TD direction, and the thermal shrinkage rate in the MD direction orthogonal to the in-plane direction was 3%.

### Example 5

<Preparation of Laminate 5>

Coating Liquid 5 for forming PEDOT/PSSS described below was prepared.

Composition of Coating Solution 5 for forming PEDOT/PSSS

| | |
|---|---|
| PEDOT/PSS (CLEVIOS PH1000, | 10.00 parts by mass |
| manufactured by Heraeus | |
| Holding GmbH) | |
| Ethanol | 27.00 parts by mass |
| Ethylene glycol | 3.00 parts by mass |

Subsequently, Coating Solution 5 for forming PEDOT/PSSS was applied to the PC film used in Example 2 by using a bar coater. The solution was dried at a film surface temperature of 130° C. for 15 minutes and cooled to 25° C. to prepare Laminate 5 using PEDOT/PSS as a conductive layer. The thickness of the conductive layer was 200 nm.

In the same manner as in Example 1, the transmittance, the sheet resistance value, and the haze of the laminate were measured according to the method described above. Results thereof are as presented in Table 1.

In the same manner as in Example 2, the Tg of the substrate used was 150° C., and the thermal shrinkage rate in the TD direction was 33%. The in-plane direction in which the thermal shrinkage rate of the substrate became the maximum was substantially identical to the TD direction, and the thermal shrinkage rate in the MD direction orthogonal to the in-plane direction was 3%.

### Example 6

<Preparation of Laminate 6>

Laminate 6 of Example 6 was prepared in the same manner as in Example 5 except for using stretched PET Film 1 used in Example 1 instead of the PC film in Example 5. The thickness of the conductive layer was 200 nm.

In the same manner as in Example 1, the transmittance, the sheet resistance value, and the haze of the laminate were measured according to the method described above. Results thereof are as presented in Table 1.

In the same manner as in Example 1, the Tg of the substrate used was 80° C., and the thermal shrinkage rate in the TD direction was 35%. The in-plane direction in which the thermal shrinkage rate of the substrate became the maximum was substantially identical to the TD direction, and the thermal shrinkage rate in the MD direction orthogonal to the in-plane direction was 10%.

### Example 7

<Preparation of Laminate 7>

With respect to the method disclosed in Example 8 of JP2015-5495A, Laminate 7 having a layer (Ag mesh) formed of silver fine particles having conductivity and an acryl-styrene composite synthetic resin having a glass transition temperature of 45° C. was prepared by the same method as Example 8 of JP2015-5495A, as a conductor, except for changing the support to the COP film used in Example 3 and changing the wiring pattern to a lattice-shaped pattern with a line width of 4 μm and a pitch of 300 μm. The thickness of the conductive layer was 1,000 nm.

In the same manner as in Example 1, the transmittance, the sheet resistance value, and the haze of the laminate were measured according to the method described above. Results thereof are as presented in Table 1.

In the same manner as in Example 3, the Tg of the substrate used was 170° C., and the thermal shrinkage rate in the TD direction was 32%. The in-plane direction in which the thermal shrinkage rate of the substrate became the maximum was substantially identical to the TD direction, and the thermal shrinkage rate in the MD direction orthogonal to the in-plane direction was 3%.

### Example 8

<Preparation of Laminate 8>

In Example 1, instead of ITO, Laminate 8 of Example 8 was prepared in the same manner as in Example 1 except for forming a film with carbon nanobuds by a Direct Dry Printing (DDP) method disclosed in page 1012 of SID 2015 DIGEST, as a conductor. The thickness of the conductive layer was 100 nm.

In the same manner as in Example 1, the transmittance, the sheet resistance value, and the haze of the laminate were measured according to the method described above. Results thereof are as presented in Table 1. In this example, since the insulating layer was laminated on the conductive layer, the measurement was performed using the resistance meter (EC-80P, High probe manufactured by Napson Corporation) after calibration.

In the same manner as in Example 1, the Tg of the substrate used was 80° C., and the thermal shrinkage rate in the TD direction was 35%. The in-plane direction in which the thermal shrinkage rate of the substrate became the maximum was substantially identical to the TD direction, and the thermal shrinkage rate in the MD direction orthogonal to the in-plane direction was 10%.

[Evaluation of Sheet Resistance Value and Haze Value After Shrinkage (Reference)]

After the laminate prepared in each of the above examples was shrunk at a magnification (shrinkage rate) presented in Table 1 by a method described below, and the sheet resistance value and the haze value after shrinkage were evaluated. Measurement of the sheet resistance value and the haze value was performed by the same method as the measurement before shrinkage. Results thereof are as presented in Table 1.

<Shrinkage>

Each sample was shrunk by using a tension tester (AUTOGRAPH AGS-J load cell 5 KN) manufactured by Shimadzu Corporation and a high-temperature tank (TCE-N 300 manufactured by Shimadzu Corporation).

First, at the room temperature, 30 mm×10 mm on both ends in the longitudinal direction of a sample which was cut into 30 mm×120 mm were chucked to a forcep holding device of a tension tester and set as a pinching margin. With respect to 30 mm×100 mm of the sample set between the chucks, the distance between the upper and lower chucks was set such that the shrinkage rate after shrinkage became the value as presented in Table 1, and the sample was set in a loosened state. For example, in a case where the shrinkage rate was 10%, the distance between the chucks was set to 90 mm, and the distance between chucks was set such that the sample having the length of 100 mm became length of 90 mm after shrinkage. In this state, the sample was gradually heated to the shrinkage temperature (glass transition temperature), such that shrinking the sample was shrunk to have a predetermined shrinkage rate. The shrinkage of the sample to the predetermined length was checked by monitoring the tension increase of the tension tester.

TABLE 1

| | Substrate | | | | | | | After shrinkage | | |
|---|---|---|---|---|---|---|---|---|---|---|
| | | | Thermal | | | Sheet resistance | | Shrinkage | Sheet | |
| | | Tg | shrinkage | Conductive | Transmittance | value | Haze | rate | resistance value | Haze |
| | Type | (° C. ) | rate (%) | layer | (%) | (Ω/□) | (%) | (%) | (Ω/□) | (%) |
| Example 1 | PET | 80 | 35 | ITO | 85 | 25 | 0.5 | 10 | 30 | 5.2 |
| Example 2 | PC | 150 | 33 | ITO | 85 | 25 | 0.5 | 10 | 32 | 4.6 |
| Example 3 | COP | 170 | 32 | ITO | 85 | 25 | 0.5 | 10 | 29 | 3.9 |
| Example 4 | Cellulose | 180 | 30 | ITO | 85 | 25 | 0.5 | 10 | 35 | 4.9 |
| Example 5 | PC | 150 | 33 | PEDOT/ | 81 | 101 | 1.7 | 20 | 83 | 3.6 |
| | | | | PSS | | | | | | |
| Example 6 | PET | 80 | 35 | PEDOT/ | 81 | 120 | 1.7 | 10 | 117 | 5.7 |
| | | | | PSS | | | | | | |
| Example 7 | COP | 170 | 32 | Ag mesh | 91 | 20 | 4.0 | 20 | 20 | 0.6 |
| Example 8 | PET | 80 | 35 | CNB | 85 | 140 | 0.8 | 20 | 140 | 0.8 |

### Reference Examples 1 to 8

<Evaluation of Sheet Resistance Value and Haze Value After Stretching>

The heat shrinkable films with the transparent conductive films prepared in Examples 1 to 8 were stretched at a stretching ratio presented in Table 2 below by a method described below, and the sheet resistance value and the haze value after stretching were evaluated. Measurement of the sheet resistance value and the haze value was performed by the same method as the measurement before stretching. Results thereof are as presented in Table 2.

<Stretching>

Each sample was stretched by using a tension tester (AUTOGRAPH AGS-J load cell 5 KN) manufactured by Shimadzu Corporation and a high-temperature tank (TCE-N 300 manufactured by Shimadzu Corporation).

First, at the room temperature, 30 mm×10 mm on both ends in the longitudinal direction of a sample which was cut into 30 mm×120 mm were chucked to a forcep holding device of a tension tester and set as a pinching margin. With respect to 30 mm×100 mm of the sample set between the chucks, the distance between the chucks was set to 100 mm, which was the same as the length of the sample, such that the sample was not loosened. After heating the sample to a predetermined temperature for 2 minutes, the sample was stretched at a speed of 100 mm/min such that the stretching ratio after stretching became the value presented in the following table 2.

TABLE 2

| | Substrate | | | | | Sheet | | After stretching | | |
|---|---|---|---|---|---|---|---|---|---|---|
| | | | Thermal | | | resistance | | Stretching | Sheet resistance | |
| | | Tg | shrinkage rate | Conductive | Transmittance | value | Haze | ratio | value | Haze |
| | Type | (° C. ) | (%) | layer | (%) | (Ω/□) | (%) | (%) | (Ω/□) | (%) |
| Reference | PET | 80 | 35 | ITO | 85 | 25 | 0.5 | 10 | Unmeasurable | |
| Example 1 | | | | | | | | | | |
| Reference | PC | 150 | 33 | ITO | 85 | 25 | 0.5 | 10 | Unmeasurable | |
| Example 2 | | | | | | | | | | |
| Reference | COP | 170 | 32 | ITO | 85 | 25 | 0.5 | 10 | Unmeasurable | |
| Example 3 | | | | | | | | | | |
| Reference | Cellulose | 180 | 30 | ITO | 85 | 25 | 0.5 | 10 | Unmeasurable | |
| Example 4 | | | | | | | | | | |
| Reference | PC | 150 | 33 | PEDOT/ | 81 | 101 | 1.7 | 20 | 553 | 50 |
| Example 5 | | | | PSS | | | | | | |
| Reference | PET | 80 | 35 | PEDOT/ | 81 | 120 | 1.7 | 10 | 536 | 50 |
| Example 6 | | | | PSS | | | | | | |
| Reference | COP | 170 | 32 | Ag mesh | 91 | 20 | 4.0 | 20 | Unmeasurable | |
| Example 7 | | | | | | | | | | |
| Reference | PET | 80 | 35 | CNB | 85 | 140 | 0.8 | 20 | 200 | 0.8 |
| Example 8 | | | | | | | | | | |

From the results shown in Table 2, it was found that, in a case where the substrate of the transparent conductive film was stretched, in a case where the substrate was stretched by 10% or greater, the sheet resistance value deteriorated to 200 Ω/□ or greater (Reference Examples 1 to 8).

On the contrary, as presented in Table 1, it was found that, in the case where the substrate was constricted by using the thermal shrinkable film of the present invention, even if materials of the substrate and the transparent conductive film were different, the increase in the resistance values were able to be improved, the resistance value before the shrinkage was able to be maintained (Examples 1 to 8). Particularly, in Example 8 in which CNB was used for a transparent conductive film, even if the substrate was constricted by 20%, changes of the resistance value or the haze (transparency) were not observed.

### Example 9

Laminate 2 prepared in Example 2 was cut into a width of 10 cm and a length of 30 cm such that the short sides were overlapped with each other to have a width of 1 cm, the long sides were rounded to form a cylindrical tubular shape, and the overlapped portion was fixed by thermocompression by applying the pressure of 1 MPa at 150° C. for one minute, so as to prepare Laminate 9 having a sleeve shape. The circumferential length was 29 cm.

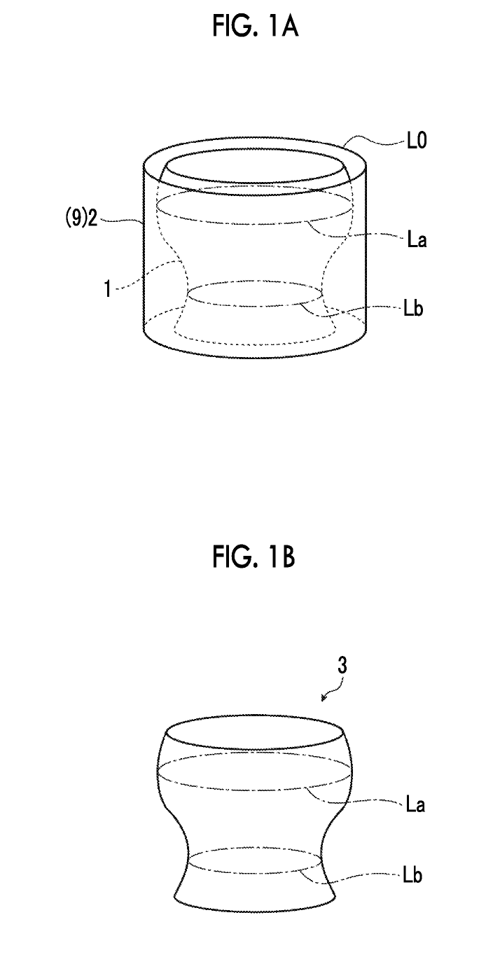

In Mold 1 having the shape presented in FIG. 1A, the longest circumferential length was La=25 cm, and the shortest circumferential length was Lb=20 cm. Laminate 9 consisting of Laminate 2, having a circumferential length L0 of 29 cm, and having a sleeve shape was placed on the outside of this mold and was heated for five minutes at a temperature of 150° C. so as to prepare Liquid Crystal Cell 3 having a three-dimensional structure as illustrated in FIG. 1B.

Prepared Liquid Crystal Cell 3 having a three-dimensional structure was molded such that Laminate 9 followed to any one of the portions of the circumferential length La and the circumferential length Lb in a satisfactory manner, and the circumferential lengths of Laminate 9 of the respective portions were 25 cm and 20 cm as in the mold. It was checked that, the transmittance after molding was 85%, the haze value was 4.6%, the resistance value was 28 Ω/□, and satisfactory optical characteristics and electrical characteristics were able to be maintained.

### Comparative Example 1

In Example 2, Laminate 10 of Comparative Example 1 was prepared in the same manner as in Example 2 except for changing the stretched PC film to a biaxially stretched PET film (A4300 manufactured by Toyobo Co., Ltd., thickness 300 μm) stretched by 100% in the TD direction at a stretching temperature of 200° C.

The transmittance, the sheet resistance value, and the haze of the laminate were measured according to the method described above in the same manner as in Example 1, the transmittance was 85%, the sheet resistance value was 25 Ω/□, and the haze value was 0.5%. The Tg of the substrate used was 80° C. and the thermal shrinkage rate was 0.5%.

Laminate 10 was heated and molded in the same manner as in Example 9, except for using Laminate 10 prepared above instead of Laminate 9 and setting the temperature in a case of the heat molding to 200° C. in Example 9. The transmittance of Laminate 10 after molding was 80%, the haze value was 50%, the resistance value was 70 Ω/□, and the haze value was greatly deteriorated. The surface shape was observed to recognize unevenness on the entire surface, and thus it is possible to assume that the cause of the deterioration of the haze value was caused by the difference between the shrinkage rates of the PET film and ITO. In addition, due to the crystallinity of the biaxially stretched PET film, shrinkage was difficult, both of the portion of the circumferential length La and the portion of the circumferential length Lb did not follow the mold, and the circumferential lengths of the respective portions were 27.5 cm and 27.3 cm.

### Comparative Example 2

Laminate 10 prepared in Comparative Example 1 was wound around a mold having the shape illustrated in FIG. 1 and was caused to follow the mold at a heating molding temperature of 200° C. while both ends thereof were stretched. All of the portion of the circumferential length La and the portion of the circumferential length Lb followed the mold, but ITO was disconnected and the resistance value was not able to be measured. The external appearance was whitened because cracks of ITO were generated on the entire surface.

### EXPLANATION OF REFERENCES

1 mold

2 laminate

3 liquid crystal cell having three-dimensional structure

9 laminate having sleeve shape

L0 circumferential length before shrinkage

La longest circumferential length

Lb shortest circumferential length

What is claimed is:

1. A laminate comprising:
a substrate; and
a conductive layer,
wherein a haze value is less than 10%, and
wherein a thermal shrinkage rate of the substrate is 5% to 75%.

2. The laminate according to claim 1,
wherein the conductive layer is a transparent conductive layer, and
wherein a transmittance of the laminate is 60% or greater.

3. The laminate according to claim 1,
wherein a thickness of the substrate is 10 to 500 μm.

4. The laminate according to claim 2,
wherein a thickness of the substrate is 10 to 500 μm.

5. The laminate according to claim 1,
wherein the substrate is stretched in a range of greater than 0% and 300% or less.

6. The laminate according to claim 2,
wherein the substrate is stretched in a range of greater than 0% and 300% or less.

7. The laminate according to claim 3,
wherein the substrate is stretched in a range of greater than 0% and 300% or less.

8. The laminate according to claim 4,
wherein the substrate is stretched in a range of greater than 0% and 300% or less.

9. The laminate according to claim 1,
wherein the substrate is not stretched.

10. The laminate according to claim 2,
wherein the substrate is not stretched.

11. The laminate according to claim 3,
wherein the substrate is not stretched.

12. The laminate according to claim 4,
wherein the substrate is not stretched.
